(19) United States
(12) Patent Application Publication
(10) Pub. No.: US 2015/0034530 A1
(43) Pub. Date: Feb. 5, 2015

(54) Solvent Extraction of Bitumen Using Heat From Combustion of Product Cleaning Streams

(71) Applicant: EXXONMOBIL UPSTREAM RESEARCH COMPANY, Houston, TX (US)

(72) Inventors: Brian C. Speirs, Calgary (CA); Fritz Pierre, JR., Humble, TX (US); Payman Esmaeili, Houston, TX (US); David C. Rennard, Houston, TX (US); Justin D. Pace, Houston, TX (US)

(21) Appl. No.: 14/347,566

(22) PCT Filed: Oct. 9, 2012
(86) PCT No.: PCT/US12/59390

§ 371 Date: Mar. 26, 2014

(30) Foreign Application Priority Data
Dec. 19, 2011 (CA) 2762444

(51) Int. Cl. C10G 1/04; F23J 7/00; F23G 7/05; C01B 3/02; F23G 5/027

(52) U.S. Cl. CPC C10G 1/045; C01B 3/02; F23G 5/027; F23G 7/05; F23J 7/00
USPC 208/390; 252/373; 110/346; 431/11; 110/342

(57) ABSTRACT

Described herein is a process that employs heat, derived from the combustion of product cleaning streams, such as waste streams, in a solvent-based extraction process. Solvent extraction of bitumen generally involves combining solvent with a bituminous feed to produce a cleaned bitumen product. Solvent is recovered, for example by utilizing heat to cause evaporation, and recovered solvent may be re-used. In an exemplary embodiment, hot flue gas from waste stream combustion may provide the heat to evaporate the solvent. Product cleaning waste streams may be ones produced from the trim cleaning of solvent extracted bitumen or from treatment of bitumen froth produced in a water-based extraction process. The heat generated can contribute to the energy requirements of the overall solvent extraction of bitumen.

### CROSS REFERENCE TO RELATED APPLICATIONS

This application claims the priority benefit of Canadian Patent Application 2,762,444 filed Dec. 19, 2011 entitled SOLVENT EXTRACTION OF BITUMEN USING HEAT FROM COMBUSTION OF PRODUCT CLEANING STREAMS, the entirety of which is incorporated by reference herein.

### FIELD

Described herein are processes for hydrocarbon extraction from mineable deposits, such as bitumen from oil sands.

### BACKGROUND OF THE INVENTION

Processes for extracting hydrocarbon from oil sands often require energy intensive processing steps to separate solids and water from the products having commercial value.

### BACKGROUND

Oil sands are sand deposits which in addition to sand, contain clays, connate water and bitumen. Depending on geographic location, bitumen may be recovered by mining methods or in-situ thermal oil recovery methods. Oil sands ore in a mining and extraction operation is typically processed using mechanical and chemical techniques to separate the bitumen from the sands. In general, water-based extraction and solvent-based extraction are the two processes that have been proposed or used to extract bitumen from mined oil sands. In the case of water-based extraction, water is the dominant liquid in the process and the extraction occurs by having water displace the bitumen on the surface of the solids. In the case of solvent-based extraction, the solvent is the dominant liquid and the extraction of bitumen occurs by dissolving bitumen into the solvent.

One of the most commonly employed water-based extraction processes is bitumen froth flotation. In this process, hot water, air and process aids are mixed with the oil sands resulting in bitumen droplets that attach to or coat air bubbles. The aerated bitumen rises under gravity to form a distinct hydrocarbon phase, known as bitumen froth, which can be separated from the aqueous layer. The remaining aqueous phase comprised of sand, clay, water and un-recovered bitumen are known as tailings. The typical composition of the bitumen froth stream is about 60 wt % bitumen, 30 wt % water and 10 wt % solids. The water and solids in the froth are considered to be contaminants and are removed in a product cleaning process, referred to as the froth treatment process, to a level suitable to feed the bitumen to an oil refinery or an upgrading facility.

In order to produce water extracted bitumen of suitable quality for an oil refinery, paraffinic froth treatment (PFT) is used for the product cleaning of the bitumen froth. An example of PFT is described in Canadian Patent Nos. 2,149,737 and 2,217,300. In the PFT process a sufficient amount of paraffinic solvent is mixed with the bitumen froth in order to induce the precipitation of asphaltenes within the bitumen. The precipitated asphaltenes form aggregates with the contaminants (entrained water and carryover solids in the froth) that readily settle under gravity or enhanced gravity separation. PFT settling vessels are sized to allow gravity settling of the contaminants to provide a solids-free dry bitumen product (<300 ppm solids, <0.5 wt % BS&W) suitable for transportation in a common carrier to refineries. Bitumen of such quality is termed fungible because it can be processed in conventional refinery processes, such as hydroprocessing, without dramatically fouling the refinery equipment.

The PFT process is the primary commercial method of producing a fungible bitumen product from water extracted bitumen. However, the process produces wet tailings that contain a significant amount of asphaltenes bound with water and fine particles. The tailings are considered waste and are currently disposed of into tailings ponds. Within the tailings pond, some of the water from the PFT tailings is recovered as the solids and asphaltenes settle due to gravity. This is not an ideal method of handling PFT tailings for several reasons. First, a significant amount of time is required for most of the solid materials to settle out of the tailings by operation of gravity alone. Secondly, most of the specific heat of the tailings, which is at a temperature between 70° C. to 90° C., is lost to the environment in the tailings pond. Lastly, the large amounts of hydrocarbons lost in the tailings pond (about 15 k-bbls/day for a 10 k-tons/hr extraction plant) may have value, and thus the utilization of these hydrocarbons could reduce environmental and safety issues relating to tailings ponds. Thus, there exists a need to more effectively use the product cleaning waste streams of the PFT process.

Solvent-based extraction processes for the recovery of bitumen from mined oil sands have been proposed as an alternative to water-based extraction since, among other benefits, solvent-based extraction processes have the potential to use much less water and produce bitumen that requires much less product cleaning than bitumen froth. A major challenge to the application of solvent-based extraction to oil sands is the tendency of fine particles within the oil sands to hamper the separation of solids from the bitumen extract. Solvent extraction with solids agglomeration is a technique that has been proposed to deal with this challenge. The original application of this technology was coined Solvent Extraction Spherical Agglomeration (SESA). A more recent description of the SESA process can be found in Sparks et al., Fuel 1992 (71); pp. 1349-1353. While the previously described methodology of Sparks et al. for SESA has not been commercially adopted, newer solvent extraction processes show promise. The process described in Canadian Patent Application No. 2,724,806 (Adeyinka et al.) entitled “Processes and Systems for Solvent Extraction of Bitumen from Oil Sands” is one such example of a promising solvent-based extraction process.

In general, the SESA process involves mixing oil sands with a hydrocarbon solvent to form a slurry, adding a bridging liquid to the oil sands slurry, agitating the mixture in a slow and controlled manner to nucleate particles, and continuing such agitation to permit these nucleated particles to form larger multi-particle spherical agglomerates for removal. The bridging liquid is preferably water or an aqueous solution since the solids of oil sands are mostly hydrophilic and water is immiscible with hydrocarbon solvents. It has been found the bridging liquid used in the process can be water with both a high fines and salt content. In fact, in certain embodiments of the SESA process it may be preferable to have aqueous bridging liquid with either high fines content and/or high dissolved solid content.

One of the earliest SESA process described was published by Meadus et al. in U.S. Pat. No. 4,057,486. This process involves combining solvent extraction with solids agglomeration to achieve dry tailings suitable for direct mine refill. In the process, organic material is separated from oil sands by mixing the oil sands material with an organic solvent to form a slurry, after which an aqueous bridging liquid is added in the amount of 8 to 50 wt % of the feed mixture. By using controlled agitation, solid particles from oil sands come into contact with the aqueous bridging liquid and adhere to each other to form macro-agglomerates of a mean diameter of 2 mm or greater. The formed agglomerates are more easily separated from the organic extract compared to un-agglomerated solids. The organic extract free agglomerates can be sintered at high temperatures to make useful construction material. For example, halide salts such as NaCl, KCl, and CaCl₂ can be dissolved in the aqueous bridging liquid to form agglomerates that when sintered at temperatures greater than 500° C. to produce very strong aggregates.

U.S. Pat. No. 4,719,008 (Sparks et al.) describes a solvent extraction process with solids agglomeration process that is more suitable for varying ore grades. The process uses a micro-agglomeration procedure in which the fine particles of the oil sands are consolidated to produce agglomerates with a similar particle size distribution to the coarser grained particles of the oil sands. Using this micro-agglomeration procedure, the solid-liquid separation behavior of the agglomerated oil sands will be similar regardless of ore grade. The micro-agglomeration process is described as occurring within a slowly rotating horizontal vessel. The conditions of the vessel favor the formation of large agglomerates; however, a light milling action is used to continuously break down the agglomerates. The micro-agglomerates are formed by obtaining an eventual equilibrium between the cohesive and destructive forces of the agglomeration process.

Solvent-based extraction processes typically produce extracted bitumen with much less solids and water content than that of bitumen froth. For examples, the bitumen extract from the solvent extraction with solids agglomeration process described above typically has as solids content and water content of less than 2 wt % and 1 wt % respectively. However, this residual amount of solids and water still renders the bitumen unsuitable for marketing and thus a product cleaning process is required to produce a fungible bitumen product. The product cleaning process may involve physical separation methods such as gas flotation, gravity separation, enhanced gravity separation or membrane filtration. Other product cleaning methods involve partially deasphalting the bitumen extract combine with a separation method such as gravity settling. U.S. Pat. No. 4,572,777 (Peck) and U.S. Pat. No. 4,888,108 (Farnand) describe methods of partially deasphalting solvent extracted bitumen in order to remove residual solids in the bitumen extract.

Many product cleaning processes for solvent extracted bitumen result in a waste stream that contains a significant amount of residual bitumen along with the solids and, to a lesser extent, water. Typical methods for recovering the residual bitumen involve washing the waste stream with additional solvent or directing the waste stream upstream of the solvent extraction process. Both these methods have the disadvantage of potentially recontaminating the bitumen extract with the once removed solids and water. Thus, it is desirable to find other purposes for waste streams.

The solvent wet tailings produced in a solvent-based extraction process may have a solvent content between 5 to 20 wt % after solid-liquid separation. This excess solvent is typically removed from the solids in a dryer (sometimes referred to as a tailings solvent recovery unit or TSRU), where heat is used to evaporate the solvent from the solids. Because solvent drying requires a significant amount of energy and time, dry tailings generated from the solvent recovery units may contain residual solvent that is uneconomical to recover. This solvent poses safety and environmental risks. For example, the solvent can pool and accumulate depending on atmospheric and geologic conditions. Wind driven solvent plumes could pose significant safety and environmental issues and may affect operations. To ensure safe operating conditions, it is therefore necessary to remove even uneconomically recoverable solvent from dried tailings. It is currently believed that a solvent content of 400 ppm or less will be the limit required for environmentally acceptable dry tailings. Thus solvent removal is a necessary, but is a energy intensive aspect of the solvent-based extraction process.

The use of combustion processes to aid in bitumen extraction of mined oil sands is well known in the art. For example U.S. Pat. No. 4,306,981 (Taciuk) describes a processor that comprises concentric, radially spaced, horizontal inner and outer tubular members connected for rotation together. The processor's multiple chambers are used to process the oil sands in multiple steps. The oil sands undergoes i) heating to remove water, ii) pyrolysis during which light hydrocarbons are vaporized and heavy hydrocarbons are broken down by thermal cracking, and iii) the inert organics that remain as coke deposited on the solids are combusted to generate process heat.

U.S. Pat. No. 4,880,528 (Westhoff et al.) describes a method that uses a cyclone retort to pyrolyze oil sand. Portions of the gases removed from the cyclone retort are heated by heat exchange with combustion flue gas and then are recycled back to the cyclone retort chamber. The carbon-containing solids from the cyclone retort are sent to a burner for burning the coke deposited on the solids in order to produce the combustion flue gas.

U.S. Pat. No. 5,320,746 (Green et al.) describes a process where the bitumen lean stream resulting from a water-based extraction process undergoes pyrolysis in a chamber containing fluidized particles. The resulting carbon-containing solids from the pyrolysis chamber are directed to a combustion chamber where the coke deposited on the solids are combusted to generate process heat.

U.S. Patent Application No. 2008/0290000 (Towler) describes a process where oil sands are fed directly in a fluid catalytic cracking (FCC) apparatus. Within the FCC, the heated solids cause vaporization and produce gaseous product streams that are separated out in a separating vessel. The solids from the FCC are directed to a gasifier where the coke deposited on the solids and the residual oil are combusted.

There exists a need to more effectively treat the product cleaning waste steams of solvent extracted bitumen. There also exists a need to reduce the amount of natural gas used to generate the heat required in the solvent recovery units of a solvent-based extraction process. The level of solvent recovery from the solids is considered one of the most important factors in the successful commercialization of the solvent-based extraction process. There also exists a need to ensure that the solvent content within dry tailings remain below their environmental limits regardless of process upsets, feed variations and other potential issues.

The following list outlines documents that may be helpful to the reader by way of background: Canadian Patent No. 2,149,737; Canadian Patent No. 2,217,300; Canadian Patent No. 2,674,660; Canadian Patent No. 2,689,469; Canadian Patent Application No. 2,724,806; Sparks et al., Fuel 1992, v(71); pp. 1349-1353; U.S. Pat. No. 4,057,486; U.S. Pat. No. 4,719,008; U.S. Pat. No. 4,572,777; U.S. Pat. No. 4,888,108; U.S. Pat. No. 4,306,981; U.S. Pat. No. 4,880,528; U.S. Pat. No. 5,320,746; U.S. Patent Application No. 2008/0290000; U.S. Pat. No. 4,180,455; U.S. Pat. No. 4,280,897; U.S. Pat. No. 4,285,773; U.S. Pat. No. 5,217,578; U.S. Pat. No. 5,366,596; U.S. Pat. No. 5,607,577; U.S. Pat. No. 6,203,765 and U.S. Pat. No. 6,589,417

It is desirable to provide processes that increase the efficiency of oil sands extraction, reduce water use, and/or reduce energy intensity required to produce a commercially desirable bitumen product from oil sands.

### SUMMARY

Processes and systems are described herein which utilize heat from the combustion of product cleaning waste streams in a solvent-based bitumen extraction process. The product cleaning waste stream can be that from the product cleaning of bitumen extracted in a solvent-based extraction process and/or product cleaning of bitumen froth produced in a water-based extraction process. The heat generated from the combustion of the product cleaning waste stream may be used in the solvent recovery units of a solvent-based extraction process or for other processes where a large amount of heat is needed. The heat may be used in the recovery of solvent from the solvent wet solids of the solvent-based extraction process. Additionally, the heat generated from the combustion of product cleaning waste can be used to thermally crack hydrocarbons within the waste steam in order to recover additional light hydrocarbons. The combustion of the solvent wet tailings can also be used to effect more complete removal of solvent from tailings to meet stringent environmental requirements.

In the context of extraction of bitumen from oil sands, product cleaning is described as the process where residual solids and water are removed from the predominately hydrocarbon stream. An example of product cleaning is paraffinic froth treatment (PFT). In this process, the solids and water within the bitumen froth formed in a water-based extraction process are made to settle out of the froth by partially deasphalting the bitumen. Another example is the partial deasphalting of a bitumen/solvent mixture formed in a general solvent-based extraction process. Solvent extraction of bitumen generally involves combining solvent with a bituminous feed to produce a bitumen product. Solvent is recovered and may be re-used. The hot flue gas from combustion of the waste stream's hydrocarbons provides the heat either directly and/or indirectly to evaporate solvent. Therefore, it is efficient to employ energy derived from a waste to reduce the energy requirements of the solvent extraction process.

The solvent extraction may be, but is not limited to, one described below or one described in the background section.

Described herein is a process for generating heat from extracting oil from oil sands ore. The process comprises contacting the oil sands ore with a solvent to form an oil sands slurry; separating the oil sands slurry into a high solids stream and a low solids stream, where the high solids stream comprises of the majority of the solids within the oil sands slurry; removing solvent and bitumen from the high solids stream to from a dry solids stream, where the dry solids stream comprises of residual hydrocarbons; and combusting residual hydrocarbons within the dry solids stream to generate heat.

Further, there is described herein a process for extracting bitumen from a bituminous feed from oil sands, comprising generating heat according to the process described above; and effecting solvent extraction of the bituminous feed to produce a high grade bitumen product; wherein the solvent extraction comprises using the generated heat to recover solvent to producing the high grade bitumen product.

Advantageously, rather than attempting to recover the bitumen from the waste stream of the product cleaning process by re-directing it into further extraction or recycling the waste as an upstream input, the value of the waste steam as an energy source can be realized. For example, in the cases where the bitumen component of the waste stream is predominately asphaltenes, combusting the asphaltenes offers advantages over simply disposing of the waste stream. The heat produced in the combustion process can then be used in the solvent-based extraction process. As a further advantage, combustion of waste streams may be used to remove the uneconomically recoverable solvent from dried tailings so as to meet stringent environmental and safety requirements.

Other aspects and features will become apparent to those ordinarily skilled in the art upon review of the following description of specific embodiments in conjunction with the accompanying figures.

### BRIEF DESCRIPTION OF THE DRAWINGS

Embodiments will now be described, by way of example only, with reference to the attached Figures.

FIG. 1 is schematic representation of a process within the scope of the present disclosure.

FIG. 2 illustrates an exemplary embodiment of a system as described herein.

FIG. 3 illustrates an exemplary embodiment of a process described herein.

FIG. 4 is schematic representation of solvent extraction with solids agglomeration using heat from the combustion of product cleaning waste streams.

FIG. 5 illustrates a method of solvent extraction with solids agglomeration using heat from the combustion of product cleaning waste streams.

FIG. 6 illustrates a process for combustion of residual solvent from tailings derived from solvent extraction of oil sands.

### DETAILED DESCRIPTION

The process described herein utilizes heat generated from the combustion of product cleaning waste streams within the solvent-based extraction process. Product cleaning waste streams are produced from the cleaning of solvent extracted bitumen or from treatment of bitumen froth produced in a water-based extraction process. Product cleaning waste streams containing a sufficient amount of hydrocarbon can be mixed with solvent wet tailings and combusted to produce heat that can be used within the solvent-based extraction process or water-based extraction process. Additionally, the solids resulting from the combustion process may be heat-treated to a sufficient degree to render them more suitable for construction material and other uses known in the art.

Solvent extraction of bitumen generally involves combining solvent with a bituminous feed to produce a bitumen product. Solvent is recovered and may be re-used. Heat may be used in solvent recovery by various methods. For example, a low oxygen flue gas could be used to directly contact solvent wet tailings produced in the solvent extraction process, and hence assists in evaporating solvent by increasing the temperature, as well as providing a stripping action by lowering the solvent partial pressure. Recovered solvent could be condensed for reuse. Further, another embodiment permits the use of hot flue gas to transfer heat, possibly through a heat transfer surface or another fluid such as steam, so as to heat tailings or for use in recovering solvent from the bitumen extract. Steam could also be used to provide stripping action to the tailings. In such an embodiment, the hot flue gas from the combustion of the product cleaning waste streams is used to indirectly heat the solvent for recovery.

An exemplary solvent extraction process is outlined in Canadian Patent Application No. 2,724,806. However, it is understood that the processes described herein are not limited to this exemplary solvent extraction process.

Described herein is a process for generating heat from extracting oil from oil sands ore. The process comprises contacting the oil sands ore with a solvent to form an oil sands slurry; separating the oil sands slurry into a high solids stream and a low solids stream, where the high solids stream comprises of the majority of the solids within the oil sands slurry; removing solvent from the high solids stream to from a dry solids stream, where the dry solids stream comprises of residual hydrocarbons; and combusting residual hydrocarbons within the dry solids stream to generate heat.

By “majority” of the solids, it is meant that at least about 60% of the solids found in the original oil sands slurry, while the remainder may remain in the low solids stream. Preferable minimum levels of oil sands slurry solids found in the high solids stream may be, for example, 70%, 80% or 90%.

Residual solids from the low solids stream are removed to from a bitumen product and a product cleaning waste stream, wherein the product cleaning waste stream comprises residual solids and residual hydrocarbons. The dry solids stream may be combined with the product cleaning waste stream.

Solvent can be recovered from the dry solids stream.

Further, residual water may be removed from the dry solids stream.

The dry solids stream may undergo pyrolysis to recover light hydrocarbons and thermally cracked hydrocarbons.

The dry solids stream may have a sufficient amount of hydrocarbon to allow for self-sustaining combustion.

Hot flue gas from combustion may be used to recover solvent from the high solids stream and/or the dry solids stream. Further, the hot flue gas may directly contact the high solids stream and/or dry solids stream. The hot flue gas can be utilized to indirectly heat the high solids stream and/or dry solids stream. Heat from the hot flue gas may be used to produce a process steam for a solvent extraction process.

In the process described herein, the dry solids stream may be mixed with a second product cleaning waste stream, such as for example paraffinic froth treatment tailings. If used, such paraffinic froth treatment tailings may be partially dewatered before mixing with the dry solids stream. Such partially dewatered paraffinic froth treatment tailings may have a water content of 1 to 50% by weight.

In the process described herein, the dry solids stream may undergo drying, pyrolysis and/or combustion in an Alberta Taciuk Process (ATP). For example, combustion may be effected in a direct fired retorting drum. Combustion may be effected in a fluidized bed combustion chamber.

Combustion may be aided by the addition of fuel gas or any other waste stream containing hydrocarbon such as coke. Such a fuel gas may be natural gas.

In the process described herein, removing solvent may comprise evaporating and condensing the solvent.

Solids within the dry solids stream may be fused together due to high temperature treatment during combustion.

Clays within the dry solids stream may be formed into calcined clays due to high temperature treatment during combustion. When such a high temperature treatment occurs, the temperatures may range from 500 to 1000° C., or for example may be in the range of 800 to 900° C.

If calcined clays are formed, these calcined clays may be used to supplement Portland cement. Such calcined clays may be activated with sodium silicate at high pH to improve tailings consolidation.

Solids subjected to high temperature treatment may be mixed with tailings from a water-based extraction process. Such tailings from a water-based extraction process may be mature fine tailings.

According to the process described herein, the high solids stream may comprise agglomerated solids.

The oil sands slurry may be mixed with an aqueous bridging liquid, which may optionally contain halide salts.

The agglomerated solids may be fused together due to high temperature treatment during combustion. The high temperature treated agglomerates may be mixed with tailings and/or mature fine tailings from a water-based extraction process.

Advantageously, the solids subjected to high temperature treatment may be used as construction material within a mine site. Further, the agglomerates may advantageously be used as construction material within the mine site following combustion.

Combustion may occur upon addition of an emission control component, such as for example one comprising limestone.

In the process described herein, combustion may not be self-sustaining. For example, combustion may be sustained by direct combustion of one or more additional hydrocarbon sources comprising fuel gas, natural gas, waste gas, syngas, coke, or gas from a pyrolysis process. Further, combustion may be sustained by the direct combustion of additional hydrocarbons liquids in the form of product cleaning waste streams, fuel oil, diesel, diluted bitumen, or solvent blowdown. Additionally, combustion may be sustained by electric resistance heaters and/or heat lamps. Combustion may also be sustained by open flame.

The dry solids stream may be mixed with a solid or liquid oxidizer to facilitate combustion of hydrocarbons.

Optionally, a liquid slurry can be used for dust control downstream of combustion. In certain instances, the liquid slurry may be formed by combining one or more of: fresh water, pond water, brackish water, brine water, produced water from an in-situ oil recovery process, water softening waste streams, primary separation vessel tailings, middlings or mature fine tailings.

The dry solids stream may be agglomerated following combustion to improve solids handling and minimize dust formation.

The dry solids stream may undergo gasification to produce syngas.

A process for extracting bitumen from a bituminous feed from oil sands, is described herein which comprises generating heat according to any of the processes described above; and solvent extraction of the bituminous feed can be effected to produce a high grade bitumen product; wherein the solvent extraction comprises using the generated heat to recover solvent to producing the high grade bitumen product.

Recovering solvent may involve evaporating and condensing the solvent. Evaporation of solvent may be as a result of subjecting tailings to a dryer. Such a dryer may contact solvent wetted tailings directly, or alternatively, the dryer may be an indirect contact dyer.

According to the process described herein, recovered solvent may be re-used in solvent extraction.

Effecting solvent extraction may comprise: combining solvent and the bituminous feed to form an initial slurry; separating the initial slurry into a fine solids stream and a coarse solids stream; agglomerating solids from the fine solids stream to form an agglomerated slurry comprising agglomerates and a low solids bitumen extract; separating the low solids bitumen extract from the agglomerated slurry; recovering solvent from the bitumen extract, leaving high grade bitumen product. Further, any other acceptable method of solvent extraction may be utilized.

The high solids stream may comprise at least about 60%, 70%, 80% or 90% of the solids from the oil sands slurry, with the remainder of the solids from the oil sands slurry being found in the low solids stream. These threshold values may be referred to interchangeably as the “majority” of the solids. An exemplary level of solids in the high solids stream is at least about 90% of the solids from the oil sands slurry.

The processes described herein may use product cleaning streams, such as waste streams, in a solvent-based extraction process for extracting bitumen from mined oil sands. In a solvent-based extraction process, solvent is used to extract bitumen from the ore. The extracted bitumen is separated from the majority of the solids in a solid-liquid separator. The solids are then washed with additional solvent to remove residual bitumen entrained therein. The washed solids are then directed to a dryer where the solvent is evaporated from the surface of the solids. There is a large quantity of heat required to heat the solids and evaporate the solvent and accompanying water. Advantageously, the processes described herein permit product cleaning streams, such as waste streams, to be used to provide the heat needed for solvent recovery.

Washed solids can be mixed with a waste stream from a product cleaning process. The product cleaning waste steam can be that from a solvent-based extraction process or a water-based extraction process. It is preferred that the product cleaning waste stream has a sufficient amount of bitumen (or a bitumen component such as asphaltenes) that the mixture of washed solids and product cleaning waste stream can be combusted. The mixture of product cleaning waste stream and solvent washed solids are combusted to produce heat required in the solvent-based extraction process. A suitable processing units for the combustion of the solids mixture may include a combined pyrolysis and combustion apparatus. Also, gasification of the solids mixture to recover hydrocarbons in the form of syngas may be employed.

Processes are described herein which involve the use of heat, from the combustion of product cleaning waste streams, in solvent extraction of bitumen. Solvent extraction of bitumen generally involves combining solvent with a bituminous feed to produce a bitumen product. Solvent is recovered and may be re-used. The hot flue gas provides the heat to evaporate solvent. Therefore, energy from a waste product produced from product cleaning is used to reduce the energy requirements of the solvent extraction of bitumen.

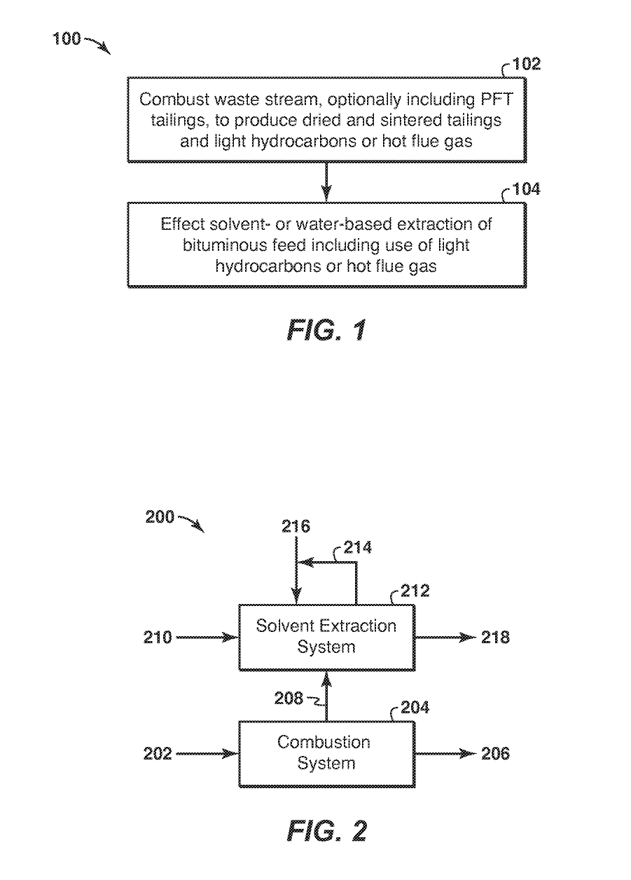

FIG. 1 is a schematic representation of an exemplary process within the scope of the present disclosure where solvent is recovered using heat energy from the combustion of product cleaning waste stream. The process 100 involves a first component 102 that entails combusting the hydrocarbon rich waste stream, which may optionally include PFT tailings to produce dried and sintered tailings and light hydrocarbons or flue gas. In the second component 104, the light hydrocarbons or hot flue gas produced is utilized to effect solvent-based or water-based extraction of a bituminous feed from oil sands, utilizing the heat to contribute to the extraction process, such as to recover solvent.

FIG. 2 illustrates a system in which hot flue gas from the combustion of product cleaning waste stream is used to evaporate solvent in the solvent extraction of bitumen. The product cleaning waste stream may be, for example, PFT tailings. Due to high water content of such tailings, such a stream is first dewatered to a water content of 50 wt % or less before combustion. In the depicted system 200, the dewatered PFT tailings 202 are combusted in a combustion system 204 producing dried tailings 206 and hydrocarbon, such as hot flue gas 208. A bituminous feed 210 is extracted using solvent extraction system 212. The solvent extraction system may be as described in Canadian Patent Application No. 2,724,806 (Adeyinka et al.), or may be another solvent extraction system including, but not limited to, those described in the background section. The solvent extraction system 212 may encompass associated solvent recycling 214 and make-up solvent 216. From the solvent extraction system 212, a high grade bitumen product 218 with low levels of fine solids is obtained.

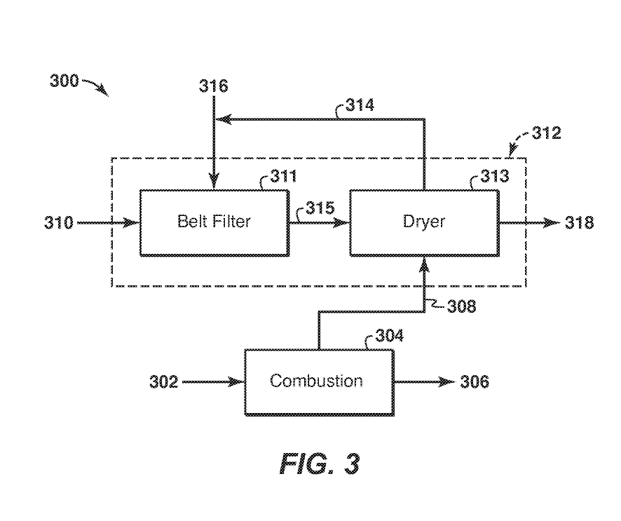

FIG. 3 illustrates a process 300 in which heat derived from combustion of a product cleaning waste stream to form hot flue gas, for example, is used to evaporate solvent in the solvent extraction of bitumen. In another embodiment of the process, the product cleaning waste stream is PFT tailings. Due to high water content of such tailings, it is first be dewatered to a water content of 50 wt % or less before combustion. In the depicted process 300, the PFT tailings 302 are then combusted by combustion 304 producing dried tailings 306 and hot flue gas 308. A bituminous feed from mined oil sands 310 is extracted using a solvent extraction process 312, which includes a belt filter 311 and a dryer 313, examples of which are described in Canadian Patent Application No. 2,724,806 (Adeyinka et al.). The solvent extraction may be as described in Canadian Patent Application No. 2,724,806 (Adeyinka et al.), or may be another solvent extraction process including, but not limited to, those described in the background section. Solvent extraction includes the associated solvent recycling 314 and make-up solvent 316. From the solvent extraction process 312, a high grade bitumen product 318 with low levels of fine solids is obtained. The hot flue gas 308 is used in the dryer 313 to evaporate solvent from solvent wet tailings 315. Canadian Patent Application No. 2,724,806 (Adeyinka et al.) provides examples of how the belt filter and dryer are used in a bitumen solvent extraction process.

Solvent extraction of bitumen requires a large quantity of heat to evaporate solvent so that it can be re-used in the process. Solvent recovery is considered to be an important economic factor. By way of a non-limiting example only, if PFT tailings from a mining operation comprise about 15,000 bbls/day (barrels/day) of hydrocarbon, combusting these tailings may provide enough process heat to recover solvent and for other process needs in the processing in the order of 10,000 tons/hr solids in a solvent extraction process.

The combustion process may be one which is capable of combusting PFT tailings to produce dried tailings and a hot flue gas comprising heat energy. The operating conditions (e.g. temperature) for this combustion will depend on the specific feed introduced. The combustion may be affected using a variety of processes, examples of which are provided below.

Prior to combustion, the PFT tailings may be dewatered to remove a portion of the water. Dewatered tailings will combust more readily owing to the removal of recovered hot water. Dewatering does not imply that all water is removed. Dewatering may be achieved by different methods such as using hydrocyclone, thickener, centrifuge, pipeline flocculation, deposition followed by natural drying or a combination of the aforementioned methods. In a preferred embodiment a thickener is used first to remove the bulk of water and reduce the water content of PFT tailings to about 40-60% weight based. The partially dewatered tailings can be sent to a secondary dewatering unit such as filtration or just being deposited for natural dewatering. Thin lift drying and rim ditching are two methods which may be used for natural drying. Chemical additives (e.g. flocculants and coagulants) may be used for dewatering step.

In an exemplary embodiment, the mixture of washed solids and product cleaning waste stream is processed in the direct fired retorting dryer as described in the Alberta Taciuk Process (ATP). Within the multiple chambers of ATP, the mixture of solvent washed solids with the product cleaning waste stream would be heated to evaporate water and any residual solvents. The dry mixture would then undergo pyrolysis to thermally crack the heavy hydrocarbons within the mixture and evaporate the resulting light hydrocarbons. The inert organics that remain as coke deposited on the solids would lastly be combusted in the combustion chamber of ATP. Additional fuel, such as evaporated solvent or natural gas may be introduced into the combustion chamber to assist the combustion process. The hot flue gas from the combustion chamber would be used to provide heat for the solvent recovery unit of the solvent-based extraction process. The hot flue gas would also be used to provide heat for the drying and pyrolysis process upstream of the combustion chamber within ATP.

The Taciuk processor could be used in embodiments of the described process. The integrated process would take the PFT tailings and combust them in the Taciuk drum. The hot flue gas from the combustion zone would be used to evaporate solvent in the bitumen solvent extraction operation. The solvent would be recovered by condensation. In addition, solvent in the PFT tailings would also be captured. Residual bitumen in the bitumen solvent extraction tailings or in the PFT tailings would be cracked along with the asphaltenes, presenting opportunity for incremental recovery of hydrocarbons.

A direct fired retorting dryer, as described in the Alberta Taciuk Process (ATP), could be used to obtain hot flue gas from PFT tailings. Another type of direct fired retorting dryer could also be used. A general description of the ATP will now be provided, followed by a description of how parts of this process could be used with embodiments described herein. ATP, also known also as the AOSTRA Taciuk Process, is an above ground dry thermal retorting technology for extracting oil from oil sands, oil shale, or other organics-bearing materials, including oil contaminated soils, sludges and wastes. In general the process uses a Taciuk processor—a horizontal, rotating vessel, which comprises multiple chambers for the different steps to separate and extract the contaminants. Waste or contaminated feed undergoes (i) heating to remove water, (ii) pyrolysis during which light hydrocarbons are vaporized and (iii) further pyrolysis in which heavy hydrocarbons are broken down by vaporization and thermal cracking. Inert organics that remain as coke deposited on the solids are oxidized to generate process heat.

During this process, the oil sand (or other feed) is moved through a rotating drum, cracking the bitumen with heat and producing lighter hydrocarbons. The ATP was originally developed for pyrolysis of oil sand. Commercially, ATP has been used for the environmental remediation of contaminated soils and for the shale oil extraction at the Stuart Oil Shale Plant in Australia. The drying and pyrolysis of the oil shale or other feed, as well as the combustion, recycling, and cooling of spent materials and residues, all occur within a single rotating multi-chamber horizontal retort. Its feed consists of fine particles. In its shale oil applications, fine particles less than 25 mm in diameter are fed into the drying zone of the retort, where they are preheated and dried indirectly by hot shale ash and hot flue gas. In the pyrolysis zone, oil shale particles are mixed with hot shale ash and the pyrolysis is performed at temperatures between 500° C. and 550° C. The resulting shale oil vapor is drawn from the retort and recovered by condensation. The char residues, mixed with ash, are moved to the combustion zone, and burnt at about 800° C. to form shale ash. Part of the ash is delivered to the pyrolysis zone, where its heat is recycled as a hot solid carrier. Most of the process energy is produced by combustion of char and produced oil shale gas.

In another embodiment described herein, the mixture of washed solids and product cleaning waste stream is process in a fluidized bed combustion chamber. Broadly speaking, fluidized beds are solid materials, usually particulate, that are subjected to certain condition to cause them to exhibit the properties and behaviors of a fluid. Solid fuels may be suspended on an upwardly-blowing current of air, causing a tumbling action that mixes gas and solid. The chamber bed may be at least partially made up of particulate matter from the solids mixture of washed solids and product cleaning waste stream. As one of ordinary skill in the art will appreciate, fluidized bed combustion allows for effective reactions and transfer of heat. For this reason, the presence of non-combustible solid material in the fluidized bed combustion chamber may not adversely affect the combustion process. Furthermore, the presence of some water in the feed may desirably reduce the combustion temperature to reduce the formation of NOx and allow for the calcining of the clays.

Low oxygen flue gas produced from the combustion process can be used directly to contact solvent wet tailings produced in the solvent extraction process. In this case, the hot flue gas would provide the heat needed to evaporate the solvent from the solids and it would provide a stripping action by lowering the solvent partial pressure. Alternatively, the hot flue gas could provide its heat indirectly by heating a heat transfer surface or another medium; for example the heating of water to make steam. The heated medium is then used to provide the heat needed to evaporate solvent from the wet tailings and/or provide heat in other process units of the solvent-based extraction process.

In some cases, there may be a high sulfur content in the solid mixture, particularly when the product cleaning waste stream is predominantly asphaltenes. As such, a SOx removal steam may be considered for the design of any combustion process used in accordance with the embodiments describes herein. In a non-limiting example, the introduction of limestone in a combustion chamber can be effect for the SOx removal. In another example, the presence of a caustic within the bridging liquid and/or product cleaning waste stream can be used to mitigate a SOx problem. Caustic is known to react with acidic gases like SO₂ that will naturally form in the combustion of sulfur containing hydrocarbons. Other emission controlling chemicals include ammonia and urea.

The process described herein is applicable to most solvent-based extraction processes since large quantities of heat are needed to recover the solvent for reuse. The solvent extraction with solids agglomeration process described in the background section and those described in Canadian Patent Application Serial No. 2,724,806 (“Adeyinka et al.”) filed Dec. 10, 2010 and entitled “Process and Systems for Solvent Extraction of Bitumen from Oil Sands” are especially suited for the process described herein. The solid agglomerates produced in the solvent-based extraction process may be heat-treated in the combustion process to produce strengthen agglomerates that are suitable for use in mine construction, composite tailings formation, and other uses well known in the art.

A brief background on PFT tailings will now be provided. Processes for extracting bitumen from mined oil sands commonly employ the steps of bitumen extraction, bitumen froth separation, and froth treatment. Froth treatment is the product cleaning step. An example of such a process will now be provided, although different processes exist. Oil sand is supplied from a mine, mixed with water, and separated from rocks and debris. The slurry is conditioned by mechanical agitation either in a hydro-transport line or a tumbler and optionally by adding chemical additives such as caustic (sodium hydroxide). The slurry is sent to a primary separation cell/vessel (PSV) where entrained air from the conditioning step results in aerated bitumen droplets that separate from most of the solids to form bitumen froth. The bitumen froth comprises bitumen, water and fine solids (also referred to as mineral solids). A typical composition of bitumen froth is about 60 wt % bitumen, 30 wt % water, and 10 wt % solids. A paraffinic solvent is combined with the bitumen froth and further separation occurs in a Froth Separation Unit (FSU). The paraffinic solvent is used to dilute the froth before separating the product bitumen by gravity. The lighter fraction from the FSU is sent to a Solvent Recovery Unit (SRU) to recover solvent for reuse from bitumen product. The bitumen product stream from the SRU is combined with a diluent to form dilbit (diluted bitumen) for transport. The tailings from the FSU are sent to a Tailing Solvent Recovery Unit (TSRU) to recover solvent leaving PFT tailings. “PFT tailings” as used herein means tailings from a paraffinic froth treatment. An example of “PFT tailings” are TSRU tailings, that is, tailings from a TSRU.

An exemplary composition of TSRU tailings, on a weight percent basis can be generally provided as: Maltenes 1%; Asphaltenes 5%; Solvent 0%; Fines 6.5%; Sands 3.3%; Water 84.3%, for a total of 100%.

The specific properties of the tailings will vary depending on the extraction method used, but tailings streams are essentially spent water, asphaltenes, unrecovered hydrocarbon, reagents, and waste ore left over once the usable bitumen has been removed.

A portion of the asphaltenes in the bitumen is also rejected by design in the PFT process thus achieving solid and water levels that are lower than those in a naphtha-based froth treatment (NFT) process.

A more detailed example of a PFT process will now be described. An example of a paraffinic solvent is a mixture of iso-pentane and n-pentane. Solvent is mixed with the bitumen froth counter-currently in an FSU, or in two stages (FSU-1 and FSU-2). In FSU-1, the froth is mixed with a solvent-rich oil stream from FSU-2. The temperature of FSU-1 is maintained at about 60 to 80° C., or about 70° C. and the target solvent to bitumen ratio is about 1.4:1 to 2.2:1 by weight or about 1.6:1 by weight. The overflow from FSU-1 is the diluted bitumen product and the bottom stream from FSU-1 is the tailings comprising water, solids (inorganics), asphaltenes, and some residual bitumen. The residual bitumen from this bottom stream is further extracted in FSU-2 by contacting it with fresh solvent, for example in a 25:1 to 30:1 by weight solvent to bitumen ratio at, for instance, 80 to 100° C., or about 90° C. The solvent-rich overflow from FSU-2 is mixed with the fresh froth feed as mentioned above. The bottom stream from FSU-2 is the tailings comprising solids, water, asphaltenes, and residual solvent. Residual solvent is recovered prior to the disposal of the tailings in the tailings ponds. Such recovery is effected, for instance, using a tailings solvent recovery unit (TSRU), a series of TSRUs or by another recovery method. Typical examples of operating pressures of FSU-1 and FSU-2 are respectively 550 kPag and 600 kPag. The foregoing is only an example of a PFT process. One method of paraffinic froth treatment is set out in Canadian Patent No. 2,587,166 to Sury.

The tailings emanating from the PFT process contain a significant quantity of asphaltenes and bitumen, bound with some water and fine clay particles. This is considered waste, and currently disposed of into tailings ponds. One known method of recovering the water is to simply direct the TSRU tailings into the tailings ponds, and allow the solid components to settle and separate from the water over time. Residual heat escapes into the atmosphere, while the tailings water is retained for future use, with some loss due to evaporation. This method is not preferred for at least three reasons. First, a significant amount of time is required for most of the solid materials to precipitate out of the tailings by operation of gravity alone. Secondly, it does not allow for the recovery of any of the large amount of energy contained within the tailings stream in the form of heat. The heat lost is high, as tailings dumped into the ponds are at temperatures between 70° C. and 90° C.

Integration with a Solvent Extraction with Solids Agglomeration Process:

In more specific embodiments, a process is described for using a solvent extraction with solids agglomeration process for extracting bitumen from minded oil sands and combusting product cleaning waste streams in order to reduce the net energy requirement of the solvent-based extraction process. In the solvent-based extraction process, bituminous feed is dissolved and extracted via an extraction liquor and solids are agglomerated via contact with a bridging liquid. The bridging liquid is preferably an aqueous stream. The extracted bitumen is separated from the agglomerates in a solid-liquid separator such as a settler and/or filter. The agglomerates may be washed with additional solvent in order to remove residual bitumen therein. All or some of the washed agglomerates are mixed with a product cleaning waste stream which comprise of a sufficient amount of combustible material to render the mixture suitable for pyrolysis and combustion. The remaining washed agglomerates are directed to a tailings solvent recovery unit (TSRU) in order to reduce the level of solvent within the agglomerates to environmentally acceptable levels. The heat-treated agglomerates produced from the combustion process may be suitable for several important uses including construction material for the mine or as a sand substitute for composite tailings technology. The flue gas produced from the combustion process is directed to the solvent recovery units of the solvent-based extraction process in order to provide heat for the recovery of solvent within the washed agglomerates and bitumen extract.

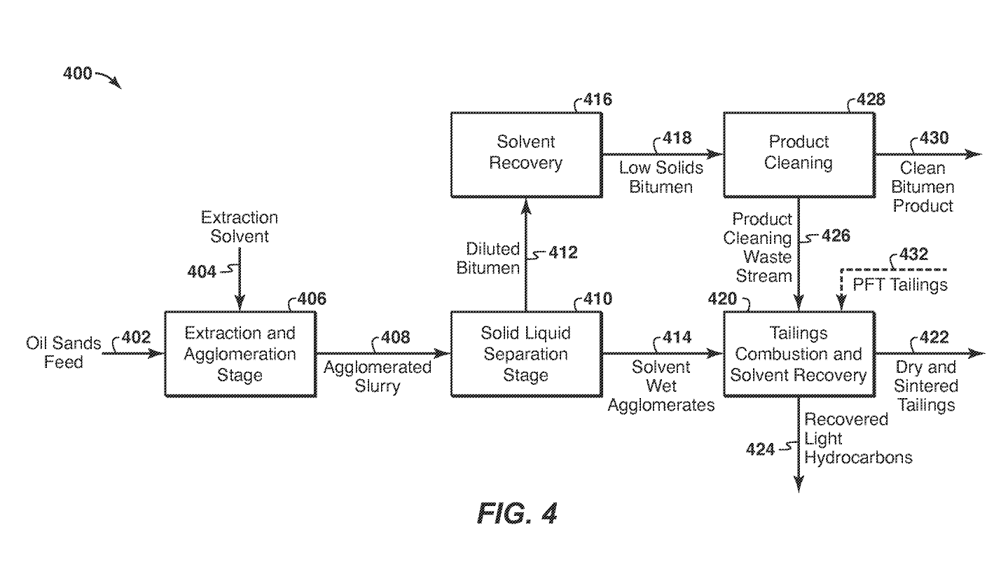

A process flow diagram of one embodiment of this process is shown in FIG. 4.

Briefly, a general method 400 of solvent extraction with solids agglomeration is shown in FIG. 4 using heat from the combustion of product cleaning streams, and in particular, a waste stream. An oil sands feed 402 is extracted using an extraction solvent 404 at an extraction and agglomeration stage 406. The extraction and agglomeration stage produces an agglomerated slurry 408 that is then processed in a solid liquid separation stage 410. Diluted bitumen 412 is added to the liquid so separated, and the next step is solvent recovery 416. Solvent wet agglomerates 414 derived from the solid liquid separation stage 410 are forwarded on to tailings combustion and solvent recovery stages 420. As a result of solvent recovery 416, low solids bitumen 418 is directed to product cleaning 428. A product cleaning waste stream 426 produced from product cleaning is directed to tailings combustion and solvent recovery 420, together with the solvent wet agglomerates 414. Optionally, PFT tailings 432, may be included in the tailings combustion and solvent recovery 420. Heat of combustion is produced at this stage. The recovered light hydrocarbons 424 produced can go on to further use, and the dry and sintered tailings 422 produced can also be utilized further. Advantageously, when a clean bitumen product 430 derived from product cleaning 428 is produced, the waste streams derived from product cleaning are put to use as well.

It is preferred that the bituminous feed is oil sands. The oil sands feed is contacted with extraction liquor that is substantially free of bridging liquid in a slurry system to produce a pumpable slurry. The slurry is well mixed in order to dissolve the bitumen. In this embodiment, the bitumen is first extracted from the oil sands prior to agglomeration in order to prevent (or limit) the agglomeration process from hampering the dissolution of bitumen into the extraction liquor and prevent bitumen occlusion within the agglomerate. In another embodiment, the bridging liquid may be directly mixed with the oil sands before or at the same time as the extraction liquor so that bitumen extraction and agglomeration occur simultaneously. In this embodiment, the bridging liquid is added before or at the same time as the extraction liquor in order to minimize the dispersion of fines, which may reduce the solids content of the bitumen extract after the agglomeration process. Additionally, the bridging liquid is added before or at the same time as the extraction liquor in order to minimize the adsorption of solvent onto the surface of the solids, which may reduce the energy required for tailings solvent recovery.

In an exemplary embodiment, the extraction liquor is a hydrocarbon solvent capable of dissolving the bitumen. The extraction liquor may be a solution of hydrocarbon solvent(s) and bitumen, where the bitumen content of the extraction liquor may range between 10 to 70 wt %. It may be desirable to have dissolved bitumen within the extraction liquor in order to increase the volume of the extraction liquor without an increase in the required inventory of hydrocarbon solvents. In cases where non-aromatic hydrocarbon solvents are used, the dissolved bitumen within the extraction liquor also increases the solubility of the extraction liquor towards dissolving additional bitumen.

It is preferred that the bridging liquid be a liquid that preferentially wets the solids of the oil sands. It is also preferred that the binding liquid be immiscible with the extraction liquor. Suitable bridging liquids include water or aqueous streams composed of water, solids and dissolved solids. Exemplary bridging liquids are aqueous streams that comprise of 1 to 2 wt % of halide salts such as NaCl, KCl, and/or CaCl₂. Agglomerates resulting from bridging liquids with such salt content are known to have strengths approaching that of concrete when sintered in air at temperatures in excess of 500° C. Other potential chemical modifiers include sodium silicate and dry caustics. The bridging liquid is added to the oil sands slurry in a concentration of less than 50 wt % of the oil sands feed. More preferably, the bridging liquid is added to the oil sands feed in a concentration of less than 25 wt %. The presence of fine particles (<44 μm) suspended within the bridging liquid may assist in the agglomeration process. For example, these fine particles may serve as seed particles for the agglomeration process.

The solvent extraction with solids agglomeration process may be used in the formation of macro-agglomerates or micro-agglomerates from the solids of oil sands. Macro-agglomerates are agglomerates that are predominantly greater than 2 mm in diameter. These agglomerates are comprised of both the fine particles (<44 μm) and the sand grains of the oil sands. Micro-agglomerates are agglomerates that are predominately less than 1 mm in diameter and they are principally composed of the fine particles of the oil sands. It has been found that the formation of micro-agglomerates are more suitable for maximizing bitumen recovery for a range of oil sands grades. However, the formation of macro-agglomerates may result in heat treated agglomerates that are more suitable for construction material.

In cases when the mixture of washed agglomerates and product cleaning waste stream has a low percentage of coke precursors, it is preferred that the mixture undergoes a pyrolysis process prior to combustion. The pyrolysis process will allow for the heavy hydrocarbons within the mixture to be thermally cracked to produce lighter hydrocarbons. The light hydrocarbons are vaporized and recovered to increases the overall liquid yield. In cases when the mixture has a high percentage of coke precursors, i.e. the hydrocarbon composition is mostly asphaltenes; it may be desirable to have the mixture simply undergo a combustion process, since the majority of the hydrocarbons will principally form coke during pyrolysis with a small fraction of liquid yield.

Integration with the Solvent Extraction with Solids Agglomeration Process Described in Canadian Patent Application Nos. 2,724,806 of Adeyinka et al.

An exemplary method of extracting bitumen from oil sands in a manner that employs solvent extraction with solids agglomeration is described in Canadian Patent Application No. 2,724,806 by Adeyinka et al., as well as in Canadian Patent Application No. 2,689,469 (from which the former application derives priority). In this process a solvent is combined with a bituminous feed derived from oil sands to form an initial slurry. Separation of the initial slurry into a fine solids stream and a coarse solids stream is followed by mixing a bridging liquid with the fine solid stream and agglomeration of solids within the fine solids stream to form an agglomerated slurry. The agglomerated slurry can be separated into agglomerates and a first low solids bitumen extract. The agglomerates are washed with additional solvent to remove residual bitumen extraction therein. The coarse solids stream can be separated into coarse solids and a second low solids bitumen extract. The coarse solids are washed with additional solvent to remove residual bitumen extract therein. The first and second low solids bitumen extract are combined and may under further processing. For example, a product cleaning process where the mixing of a second solvent with the low solids bitumen extracts to form a further diluted bitumen extract which can then be separated into low grade and high grade bitumen extracts. Recovery of solvent from the low grade and/or high grade extracts is conducted, to produce bitumen products of commercial value.

The low grade bitumen, due its high solids and water content, may have limited commercial value. In this case, the low grade bitumen is referred to as the waste stream from the product cleaning process. Low grade bitumen may be mixed with the solvent washed solids produced in a solvent-based extraction process. The mixture of low grade bitumen and solvent washed solids are combusted to produce heat required in the solvent-based extraction process. Facilities suitable for combusting this mixture include those capable of handling large solid loading. For example, the Alberta Taciuk Process (ATP) is a suitable combustion unit.

It is preferred that the low grade bitumen be mixed with the washed agglomerates to form a mixture that undergoes pyrolysis and then combustion of the residual coke. The heat treatment of agglomerates in the combustion process will result in strengthen agglomerates that may have increase value in the mine operation. Additionally, since the agglomerates and low grade bitumen mixture will comprise of most of the clays from the bituminous feed, the combustion process may result in a calcining chemical reaction converting kaolinite into metakaolin. The calcined fines can be used for solidifying or stabilizing bitumen extraction tailings, or as an additive to cement.

The hot flue gas produced in the combustion process may be directed to the tailings solvent recovery unit in order to provide the heat needed recovery solvent from the coarse solids. The hot flue gas may also be used to produce steam that can then be used in the various facilities of the solvent-based extraction process.

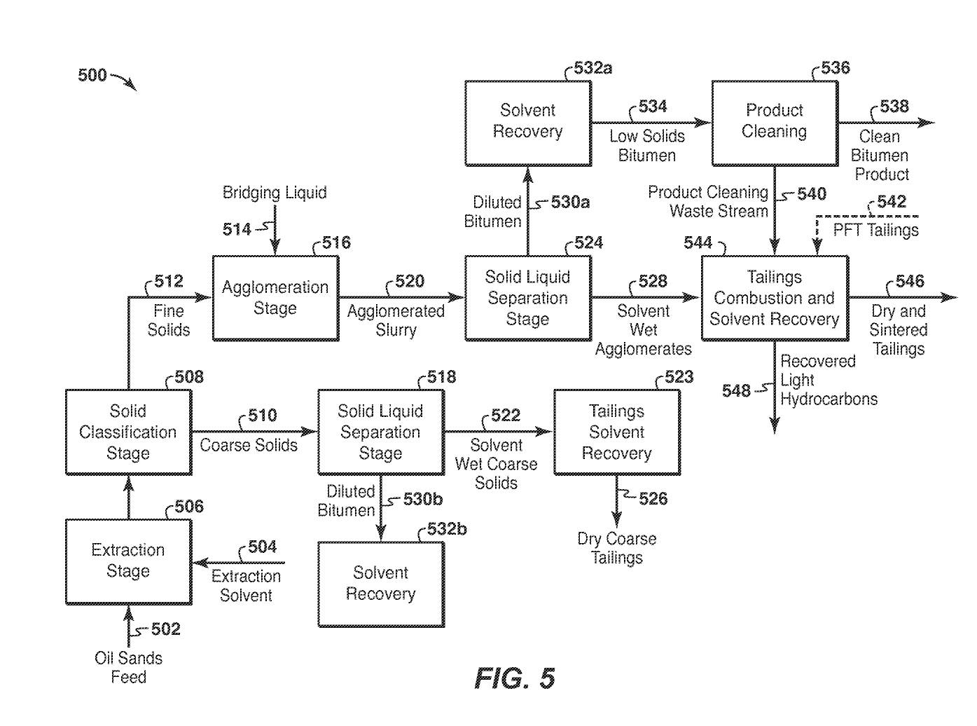

FIG. 5 illustrates a method 500 involving solvent extraction with solids agglomeration using heat from the combustion of product cleaning waste streams. This flow diagram delineates an exemplary embodiment of the combustion process described herein.

In the process shown 500, an oil sands feed 502 is provided together with an extraction solvent 504 to an extraction stage 506, from which a solid classification stage 508 follows. Coarse solids 510 derived are sent on to a solid liquid separation stage 518, while fine solids 512 are sent to an agglomeration stage 516, which involves addition of a bridging liquid 514. Following agglomeration, an agglomerated slurry 520 is formed and forwarded on to a solid liquid separation stage 524. Meanwhile, the solvent wet coarse solids 522 derived from the solid liquid separation stage 518 are forwarded on to tailings solvent recovery 523, from which dry coarse tailings 526 are derived.

The solid liquid separation stage 524 produces diluted bitumen 530a as well as solvent wet agglomerates 528. The diluted bitumen streams 530a and 530b produced from the solid liquid separation stages 524 & 518, may be directed together or separately on to solvent recovery 532a and 532b. The solvent recovery 532a and 532b can be conducted together within the same equipment by directing diluted bitumen 530a and 530b to be combined, or may be conducted separately. From solvent recovery, a stream of low solids bitumen 534 is produced and forwarded to product cleaning 536. The solvent wet agglomerates 528 derived from the solid liquid separation stage 524 may be forwarded on to tailings combustion and solvent recovery 544, and at this stage may be joined by a product cleaning waste stream 540 derived from product cleaning 536. PFT tailings 542 derived in parallel from a PFT process may be included in the tailings combustion and solvent recovery 544, and a dry and sintered tailings 546 are produced, as well as a stream of recovered light hydrocarbons 548. Ultimately, a clean bitumen product 538 is formed. The process permits the heat produced in tailings combustion and solvent recovery 544 to be formed, which may be utilized elsewhere within the process, while producing dry and sintered tailings, as well as recovered light hydrocarbons in a bitumen cleaning process.

Integration with Paraffinic Froth Treatment:

The waste stream from a paraffinic froth treatment process provides an excellent source of hydrocarbons that may be combusted in the manner described herein. A more detail description of the PFT process is described as follows. Bitumen froth, produced from a water-based extraction process, has a typical composition that is about 60 wt % bitumen, 30 wt % water, and 10 wt % solids. A paraffinic solvent is combined with the bitumen froth and the solids and water are separated from the bitumen by flocculating with the precipitated asphaltenes. An example of a paraffinic solvent is a mixture of iso-pentane and n-pentane. This solvent is mixed with the bitumen froth counter-currently in two stages of settling (FSU-1 and FSU-2). In FSU-1, the froth is mixed with a solvent-rich oil stream from FSU-2. The temperature of FSU-1 is maintained at about 60 to 80° C., or about 70° C. and the target solvent to bitumen ratio is about 1.4:1 to 2.2:1 by weight or about 1.6:1 by weight. The overflow from FSU-1 is the diluted bitumen product and the bottom stream from FSU-1 is the tailings comprising water, solids (inorganics), asphaltenes, and some residual bitumen. The residual bitumen from this bottom stream is further extracted in FSU-2 by contacting it with fresh solvent, for example in a 25:1 to 30:1 by weight solvent to bitumen ratio at, for instance, 80 to 100° C., or about 90° C. The solvent-rich overflow from FSU-2 is mixed with the fresh froth feed as mentioned above. The bottom stream from FSU-2 is the tailings comprising solids, water, asphaltenes, residual solvent and unrecovered maltenes. Typical examples of operating pressures of FSU-1 and FSU-2 are respectively 550 kPag and 600 kPag. The residual solvent within FSU-2 underflow is recovered prior to the disposal of the tailings in the tailings ponds. Such recovery is effected, for instance, using a tailings solvent recovery unit (TSRU), a series of TSRUs or by another recovery method. An example of the composition of PFT tailings is given in Table 1.

TABLE 1
Exemplary Composition of PFT Tailings

| Component | Weight Percent |
|---|---|
| Maltenes | 1 |
| Aspaltenes | 5 |
| Solvent | 0 |
| Fines | 6.5 |
| Sands | 3.3 |
| Water | 88.3 |
| Total: | 100 |

Paraffinic solvent is used to dilute the froth before separating the product bitumen by gravity. The lighter fraction from the FSU is sent to solvent recovery unit (SRU) to recover solvent for reuse and produce a fungible bitumen product. The bitumen product stream from the SRU is combined with a diluent to form dilbit (diluted bitumen) for transport. The tailings from the FSU are sent to a tailings solvent recovery unit (TSRU) to recover solvent for reuse and product PFT tailings.

Tailings emanating from the PFT process contain a significant quantity of asphaltenes and bitumen, bound with some water and fine clay particles. This is considered waste, and currently disposed of into tailings ponds. One known method of recovering the water is to simply direct the TSRU tailings into the tailings ponds, and allow the solid components to settle and separate from the water over time. Residual heat escapes into the atmosphere, while the tailings water is retained for future use, with some loss due to evaporation. This method is not preferred for at least three reasons. First, a significant amount of time is required for most of the solid materials to precipitate out of the tailings by operation of gravity alone. Secondly, it does not allow for the recovery of any of the large amount of energy contained within the tailings stream in the form of heat. The heat lost is high, as tailings directed into the ponds are at temperatures between 70° C. and 90° C. Lastly, the large amounts of hydrocarbons lost in the tailings pond (about 15 k-bbls/day for a 10 k-tons/hr extraction plant) may have value. For example, the light hydrocarbons can be recovered to increase liquid yield and reduce emissions. Additionally, the asphaltenes may be combusted to recover its heating value.

According to exemplary processes described herein, paraffinic froth treatment tailings are mixed with the solvent wash solids produced in a solvent-based extraction process. The mixture of PFT tailings and solvent wash solids are combusted to produce heat required in the solvent-based extraction process. Facilities suitable for combusting this mixture include those capable of handling large solid loading. For example, the Alberta Taciuk Process (ATP) is a suitable combustion unit. In one embodiment described herein, the PFT tailings is partially dewatered prior to mixing with solvent wash solids. The removal of water greatly reduces the required energy in the pre-combustion zones of the combustion facilities. Exemplary dewatering technologies suitable for this process include thickeners and thin lift drying.

### Production of Calcined Fines and Uses Therefor

A constituent element of the solids portion of the agglomerated fine solids and the product cleaning waste streams will be solids rich in kaolin. Kaolin, which has a chemical formula of Al₂Si2O₅(OH)₄, undergoes dehydration at temperatures of approximately 500 to 1000° C. to form metakaolin according to the following chemical reaction:

2Al₂Si₂O₅(OH)₄,→2Al₂Si₂O₇4H₂O

Reference is made to Canadian Patent Application 2,674,660 (Esmaeili et al.).

Accordingly, during combustion, the kaolin content of the mixture will undergo the above dehydration synthesis to form metakaolin once the temperature during combustion is high enough to reach the activation energy threshold for the reaction.

The calcined fines, including metakaolin, have several industrial applications attributable to cementitious, or pozzolanic, properties. Metakaolin is a well-known supplement for Portland cement; in addition, it is known to increase the compressive and flexural strengths of cement, and improve the resistance of concrete against corrosive chemicals and freeze-thaw conditions. Similarly, metakaolin may be used as the main ingredient of the geopolymer for stabilizing and solidifying water-based extraction waste streams. Accordingly, the calcined fines of this process may be used to treat other tailings streams, such as mature fine tailings (MFT), coarse tailings, or another suitable tailings streams resulting from various stages of oil sands extraction process. A chemical modifier may be mixed with the calcined fines and wet tailings mixture to improve the strength of the mixture. Esmaeili et al. describes in Canadian Patent Application 2,674,660 the use of sodium silicate and/or caustic as chemical modifiers in mixtures of fly ash with water-based extraction tailings.

Integration with the Alberta Taciuk Process:

A direct fired retorting dryer, as described in the Alberta Taciuk Process (ATP), could be used to obtain hot flue gas from a mixture of wash solids and product cleaning waste streams. A general description of the ATP will now be provided, followed by a description of how parts of this process could be used with embodiments described herein. ATP, also known also as the AOSTRA Taciuk Process, is an above ground dry thermal retorting technology for extracting oil from oil sands, oil shale, or other organics-bearing materials, including oil contaminated soils, sludges and wastes. In general the process uses a Taciuk processor—a horizontal, rotating vessel, that comprises multiple chambers for the different steps to separate and extract the contaminants. Waste or contaminated feed undergoes (i) heating to remove water, (ii) pyrolysis during which light hydrocarbons are vaporized, and (iii) further pyrolysis in which heavy hydrocarbons are broken down by vaporization and thermal cracking. The inert organics that remain as coke deposited on the solids are combusted to generate process heat.

During this process, the feed is moved through a rotating drum, cracking the heavy hydrocarbons with heat and producing lighter hydrocarbons. The ATP was originally developed for pyrolysis of oil sand. Commercially, ATP has been used for the environmental remediation of contaminated soils and for the shale oil extraction at the Stuart Oil Shale Plant in Australia. The drying and pyrolysis of the oil shale or other feed, as well as the combustion, recycling, and cooling of spent materials and residues, all occur within a single rotating multi-chamber horizontal retort. In its oil shale applications, particles less than 25 mm in diameter are fed into the drying zone of the retort, where they are preheated and dried indirectly by hot shale ash and hot flue gas. In the pyrolysis zone, oil shale particles are mixed with hot shale ash and the pyrolysis is performed at temperatures between 500° C. and 550° C. The resulting oil shale vapor is drawn from the retort and recovered by condensation. The char residues, mixed with ash, are moved to the combustion zone, and burnt at about 800° C. to form shale ash. Part of the ash is delivered to the pyrolysis zone, where its heat is recycled as a hot solid carrier. Most of the process energy is produced by combustion of char and produced oil shale gas.

The ATP process is described in U.S. Pat. No. 6,589,417 (Thermal apparatus and process for removing contaminants from oil); U.S. Pat. No. 6,203,765 (Thermal apparatus and process for removing contaminants from oil); U.S. Pat. No. 5,607,577 (Prevention of sulfur gas emissions from a rotary processor using lime addition); U.S. Pat. No. 5,366,596 (Dry thermal processor); U.S. Pat. No. 5,217,578 (Dry thermal processor); U.S. Pat. No. 4,306,961 (Process for recovery of hydrocarbons from inorganic host materials); U.S. Pat. No. 4,285,773 (Apparatus and process for recovery of hydrocarbon from inorganic host materials); U.S. Pat. No. 4,280,879 (Apparatus and process for recovery of hydrocarbons from inorganic host materials); and U.S. Pat. No. 4,180,455 (Process for thermal cracking a heavy hydrocarbon).

The Taciuk processor could be used in embodiments of the instant process. The integrated process would take a mixture of washed solids from a solvent-based extraction process and product cleaning waste stream and combust the mixture in the Taciuk drum. The light hydrocarbons from the pyrolysis zone can be further stabilized to increase liquid yield. The hot flue gas from the combustion zone would be used to evaporate solvent in the solvent-based extraction process. The heat from the hot flue gas can be used directly or indirectly. The dry tailings effluent from the ATP can be directly reclaimed or can have material uses such as construction material for the mine.

Combustion of Residual Solvent within Dry Tailings

The solvent wet tailings produced in a solvent extraction with solid agglomeration process have a typical solvent content within 4 to 5 wt % after solid-liquid separation. This excess solvent is typically removed from the agglomerates in a dryer (sometimes referred to as a tailings solvent recovery unit), where heat is used to evaporate the solvent from the solids. Because solvent drying requires a significant amount of energy and time, dry tailings generated from the solvent recovery units may contain residual solvent that is uneconomical to recover. Furthermore, process upsets may lead to spikes in the solvent content of dry tailings well above levels that are uneconomical to recover.

In one embodiment of the process described herein, the residual solvent within the dry tailings is combusted to form CO₂ and water. Since, the concentration of the residual solvent may be low, an outside energy source is used to initiate and maintain the oxidation of the residual hydrocarbons within the solids. To affect this combustion, the dry tailings can be passed through a flame or heated in an oxidative environment. More specifically, natural gas and/or gas produced in the pyrolysis process can be used as the combustion source. For examples the gases can be used to sustain a flame or the gases may be mixed the dry tailings to allow for sustain burning of the tails.

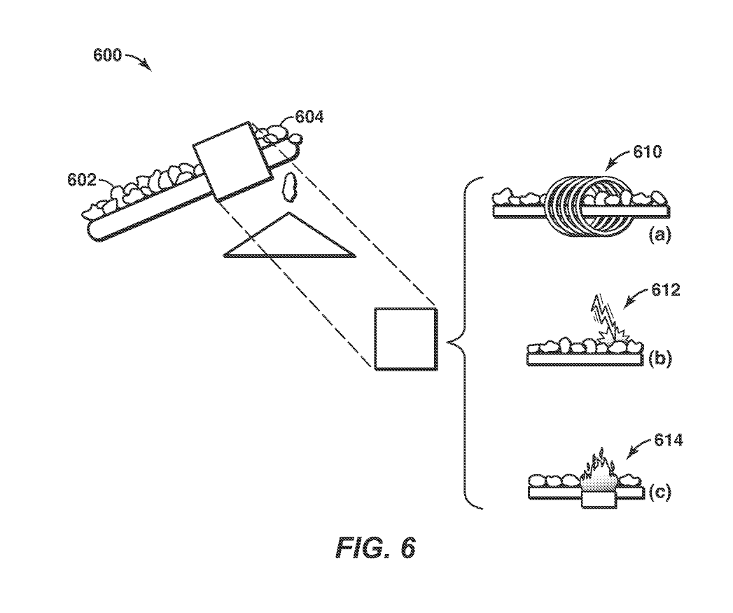

FIG. 6 illustrates processes 600 by which the residual solvents within the dry tails 602 may be combusted in a fashion consistent with the process described herein, producing dry and sintered tailings 604. In the depicted process 600, residual solvent present in tails 602 may be subject to one of three exemplary combustion processes, including in part (a), a heated coil 610, in part (b), a spark ignition 612, and in part (c), a controlled pilot flame 614. Other combustion methodologies capable of drying residual solvent from tails may be utilized.

In another embodiment of the process described herein, dry tailings are mixed with product cleaning waste streams form a solvent-based and/or water-based extraction process. The resulting mixture contains a sufficient amount of hydrocarbons such that it can undergo sustain combustion in combustion units such as the ATP process, described above.

Various optional methods for solvent extraction of bitumen from oil sands, which may be utilized in the process described herein, is provided in Canadian Patent Application No. 2,724,806 (Adeyinka et al.). Other solvent extraction methods may be utilized within the current process. The solvent extraction may involve one solvent or more, such as two solvents, as described in Canadian Patent Application No. 2,724,806 (Adeyinka et al.).

Another example of a combustion process which could be used is the Paraho process. The Paraho process can be operated in two different combustion modes, direct and indirect. The Paraho Direct process is similar to gas combustion retort technology, classified as an internal combustion method. In the Paraho Direct process, crushed raw oil shale is fed into the top of the retort through a rotating distributor. The pyrolysis of oil shale takes a place in the upper part of the retort while descending as a moving bed. The pyrolysis is caused by rising combustion gases heated in the lower part of the retort. Collecting tubes carries produced shale oil vapors and evolving gases into the product separation unit, where oil vapors are removed from gas and condensed. For combined removal of oil vapors and particulates, a wet precipitator is used. Cleaned gases are delivered to cool the spent shale and after reheating are re-circulated to pyrolyze raw oil shale. For re-heating, a combustion of char consisted in the retorted spent shale is used. The combusted takes a place in the burner in the bottom of the retort. After combustion, the spent shale delivers its heat to the re-circulated gas, which at the same time cools the spent shale. Cooled spent shale exits retort through the discharge grate in the bottom of the retort. After processing, spent shale is disposed. The Paraho Indirect technology is classified as an externally generated hot gas method. The retort's configuration is similar to the directly heated retort design except that process gas is burnt in a separate furnace and heat is carried to the retort by using circulation of heated gases. No combustion occurs in the Paraho Indirect retort itself.

A low oxygen flue gas from any of the noted combustion processes could be used to directly contact solvent wet tailings produced in the solvent extraction process, and hence both evaporate solvent by increasing the temperature, as well as providing a stripping action by lowering the solvent partial pressure. Recovered solvent would be condensed for reuse, Dryers such as rotary drums, turbo-dryers (as made by the Wyssmont Company) or fluidized bed dryers could be used for this direct contact method. Fluidized bed dryers could also receive a portion of hot ash from a Taciuk process.

As a further option, the hot flue gas could be used to heat another medium (e.g. steam) which is then used to provide heat to the tailings or for use in recovering solvent from the bitumen extract; steam could also be used to provide stripping action to the tailings; devices such as the Crown Iron Works Desolventizer-Toaster could be used.

In the preceding description, for purposes of explanation, numerous details are set forth in order to provide a thorough understanding of the embodiments. However, it will be apparent to one skilled in the art that these specific details are not required in order to practice the process.

The above-described embodiments of the invention are intended to be examples only. Alterations, modifications and variations can be effected to the particular embodiments by those of skill in the art without departing from the scope of the process described, which is defined solely by the claims appended hereto.

1. A process for generating heat from extracting oil from oil sands ore, the process comprising:
contacting the oil sands ore with a non-aqueous solvent to form an oil sands slurry;
mixing the oil sands slurry with an aqueous bridging liquid and agglomerating solids in the oil sands slurry;
separating the oil sands slurry into a high solids stream and a low solids stream, wherein the high solids stream comprises 60% or more of solids from the oil sands slurry, and the high solids stream comprises agglomerated solids;
removing the non-aqueous solvent from the high solids stream to form a dry solids stream, wherein the dry solids stream comprises residual hydrocarbons; and
combusting the residual hydrocarbons within the dry solids stream to generate heat and to fuse together the agglomerated solids due to high temperature treatment during combustion to form fused agglomerates.

2. The process of claim 1, further comprising removing residual solids from the low solids stream to form a bitumen product and a product cleaning waste stream, wherein the product cleaning waste stream comprises the residual solids and residual hydrocarbons.

3. The process of claim 2, further comprising combining the dry solids stream with the product cleaning waste stream.

4. The process of claim 2, further comprising recovering the non-aqueous solvent from the dry solids stream.

5. The process of claim 1, further comprising removing residual water from the dry solids stream.

6. The process of claim 1, wherein the dry solids stream undergoes pyrolysis to recover vaporized hydrocarbons and thermally cracked hydrocarbons.

7. The process of claim 1, wherein the residual hydrocarbons in the dry solids stream allow for self-sustaining combustion.

8. The process of claim 1, wherein hot flue gas from combustion is used to recover the non-aqueous solvent from at least one of the high solids stream and the dry solids stream.

9. The process of claim 8, wherein the hot flue gas directly contacts at least one of the high solids stream and the dry solids stream.

10. The process of claim 8, wherein the hot flue gas indirectly heats at least one of the high solids stream and the dry solids stream.

11. (canceled)

12. The process of claim 2, further comprising mixing the dry solids stream with a second product cleaning waste stream.

13. The process of claim 12, wherein the second product cleaning waste stream is paraffinic froth treatment tailings.

14. The process of claim 13, further comprising partially dewatering the paraffinic froth treatment tailings before mixing the paraffinic froth treatment tailings with the dry solids stream to form partially dewatered paraffinic froth treatment tailings.

15. The process of claim 14, wherein the partially dewatered paraffinic froth treatment tailings have a water content of 1 to 50% by weight.

16. The process of claim 1, wherein the dry solids stream undergoes at least one of drying, pyrolysis and combustion.

17. The process of claim 1, wherein combustion is effected in one of a direct fired retorting drum and a fluidized bed combustion chamber.

18. (canceled)

19. The process of claim 1, wherein combustion is aided by adding fuel gas, wherein the fuel as is natural gas.

20. (canceled)

21. The process of claim 1, wherein removing the non-aqueous solvent comprises evaporating and condensing the non-aqueous solvent.

22. (canceled)

23. The process of claim 1, further comprising forming calcined clays from clays within the dry solids stream due to high temperature treatment during combustion.

24. The process of claim 23, wherein the high temperature treatment occurs at temperatures in the range of 500 to 1000° C.

25. (canceled)

26. The process of claim 22, wherein solids subjected to the high temperature treatment are mixed with tailings from a water-based extraction process.

27. The process of claim 26, wherein the tailings from the water-based extraction process are mature fine tailings.

28. The process of claim 23, further comprising activating the calcined clays with sodium silicate at high pH.

29.-30. (canceled)

31. The process of claim 1, wherein the aqueous bridging liquid comprises halide salts.

32. (canceled)

33. The process of claim 1, wherein the fused agglomerates are mixed with at least one of tailings and mature fine tailings from a water-based extraction process.

34.-35. (canceled)

36. The process of claim 1, wherein combustion occurs after or concurrently with addition of one or more emission control components.

37. The process of claim 36, wherein the one or more emission control components comprise limestone.

38. The process of claim 1, wherein combustion is not self-sustaining.

39. The process of claim 1, wherein combustion is sustained by one of (i) direct combustion of one or more additional hydrocarbon sources comprising fuel gas, natural gas, waste gas, syngas, or gas from a pyrolysis process, (ii) the direct combustion of additional hydrocarbons in the form of product cleaning waste streams, fuel oil, naphtha, upgrading waste, coke, diesel, diluted bitumen, or solvent blowdown, (iii) at least one electric resistance heaters and heat lamps, and (iv) open flame.

40.-42. (canceled)

43. The process of claim 1, wherein the dry solids stream is mixed with one of a solid and a liquid oxidizer to facilitate combustion of hydrocarbons.

44. (canceled)

45. The process of claim 1, wherein the liquid slurry is formed by combining one or more of: fresh water, pond water, brackish water, brine water, produced water from an in-situ oil recovery process, water softening waste streams, primary separation vessel tailings, middlings, mature fine tailings, or flotation tailings.

46. The process of claim 1, wherein the dry solids stream is agglomerated following combustion to improve solids handling and minimize dust formation.

47. The process of claim 1, wherein the dry solids stream undergoes gasification to produce syngas.

48. A process for extracting bitumen from a bituminous feed from oil sands, comprising:
generating heat according to the process of claim 1; and
effecting solvent extraction of the bituminous feed with a hydrocarbon solvent to produce a high grade bitumen product;
wherein the solvent extraction comprises using the generated heat to recover the hydrocarbon solvent to produce the high grade bitumen product.

49. The process of claim 48, wherein recovering the hydrocarbon solvent comprises evaporating and condensing the hydrocarbon solvent.

50. The process of claim 49, wherein the hydrocarbon solvent is evaporated from tailings in a dryer.

51. The process of claim 50, wherein the dryer contacts solvent wetted tailings directly.

52. The process of claim 50, where the dryer is an indirect contact dryer.

53. The process of claim 48, further comprising re-using the recovered hydrocarbon solvent, in solvent extraction.

54. The process of claim 48, wherein the effecting solvent extraction comprises:
combining the hydrocarbon solvent and the bituminous feed to form an initial slurry;
separating the initial slurry into a fine solids stream and a coarse solids stream;
agglomerating solids from the fine solids stream to form an agglomerated slurry comprising agglomerates and a low solids bitumen extract;
separating the low solids bitumen extract from the agglomerated slurry;
recovering the hydrocarbon solvent from the bitumen extract, leaving high grade bitumen product.

55. The process of claim 1, wherein the high solids stream comprises at least about 60 of the solids from the oil sands slurry.

56. (canceled)
